(19) United States
(12) Patent Application Publication
(10) Pub. No.: US 2010/0308630 A1
(43) Pub. Date: Dec. 9, 2010

(54) Slumber buddy

(76) Inventor: Roshan J. Davis, Detroit, MI (US)

Correspondence Address: ROSHAN J. DAVIS, #410, 445 Field Street, Detroit, MI, 48214, US

(21) Appl. No.: 12/653,510

(22) Filed: Dec. 15, 2009

Related U.S. Application Data
(60) Provisional application No. 61/193,684, filed on Dec. 15, 2008.

(51) Int. Cl. B60N 2/42; B60N 2/26

(52) U.S. Cl. 297/250.1; 297/391

(57) ABSTRACT

A safety head harness and pillow for improving and stabilizing the head, neck, and spinal alignment positioning preferably includes a frame having spaced apart cushioned arms attached at each side of the apparatus with Velcro closures on each end, a detachable center cushioned arm with a Velcro, closure on one end and a metal snap on the other end for fastening to the metal loop in automobiles, a cushioned squared-shaped base with rounded edges which is adapted to fit over the users vehicle seat platform, a child car seat, or a child booster seat, an elasticized pulley attached to each side of the frame in the rear,'a adjustable non-stretch belt attached to each side of the frame (belt separating) in the rear having snap fasteners on each open end for modifiable purposes.

### CROSS REFERENCE TO RELATED APPLICATIONS

This application claims the benefit of provisional application Ser. No. 61/193,684 filed Dec. 15, 2008, by Roshan Jani Davis the present inventor.

### FEDERALLY SPONSORED RESEARCH

Not Applicable

### SEQUENCE LISTING OR PROGRAM

Not Applicable

### SPECIFICATION

### BACKGROUND

1. Field

This application relates to a safety head harnesses, specifically to a head harness used on sleeping passengers positioned in any type of vehicle in motion or standing still. The preferred embodiment of this invention has dual side straps and an attachable middle strap with a metal hook. More particularly, the present invention relates to child and adult vehicle seats as an attachable head harness designed to secure and position the head and neck in a safe comfortable position, and aid spinal alignment while the user is asleep or unconscious in a vehicle.

2. Prior Art

It is well-known that many standard vehicle restraint systems do not adequately protect children or adults from injury during sleep or unconsciousness while traveling in a vehicle. For example, shoulder seat belts often do not adjust sufficiently to accommodate a passenger's head, sometimes resulting in the shoulder seat belt being dangerously positioned at the passenger's neck, and also leaving the head unprotected while awake or asleep. To remedy this problem, supplemental vehicle restraints and supports, such as child car seats and head guards have become an increasingly popular way of properly restraining children and adults while traveling; thereby reducing injuries.

Background—Advantages

The Slumber Buddy is a head harness and pillow designed to protect children while traveling asleep in automobiles. The Slumber Buddy has a unique design and many competitive advantages. It has multiple uses such as being portable, easy to use, easily washable, environmentally safe, and soft to the touch.

Several types of head and neck supports were designed to hold the head into place however they may not secure the neck and head together. The Slumber Buddy serves the purpose of holding up the passengers head and securing the neck through a strapping process.

The apparatus is used by mounting the base of the device to the individuals vehicle seat platform or child booster seat with the elastic pulley or the non-stretch belt, extending the spaced apart arms across to the user's head in a criss-cross fashion, fastened with the Velcro closures, extending the center arm down the middle front of users head. From either a laying or sitting position, the user's head is supported. According to the presently preferred embodiment, the pulleys and arms on the device are adjustable to suit the user with various vehicle traveling seats.

It is a safety head harness and pillow for improving and stabilizing the head, neck, and spinal alignment positioning while asleep or unconscious in a vehicle in a vertical or horizontal placement.

### BRIEF DESCRIPTION OF DRAWINGS

FIG. 001—The front view of the child safety head harness that shows all components of the apparatus except the elastic rear band [04] and the non stretch band [05] located in the rear of the device.

FIG. 002—The side view of the child safety head harness that shows the middle and side cushioned arms extended

FIG. 003—The front view of the child safety head harness from the inside of a vehicle placed on a child that shows how the apparatus is used on a passenger one of several ways connecting the apparatus to a vehicle.

FIG. 004—The back view of the child safety head harness that shows an elastic pulley that extends across the back of base; also, and the adjustable non-stretch rear strap is shown.

FIG. 005—The front view of the child safety head harness that shows the overlapping arms and middle arm displaying the structure of the design of the child safety head harness as previously shown in FIG. 003.

### DESCRIPTION OF DRAWINGS

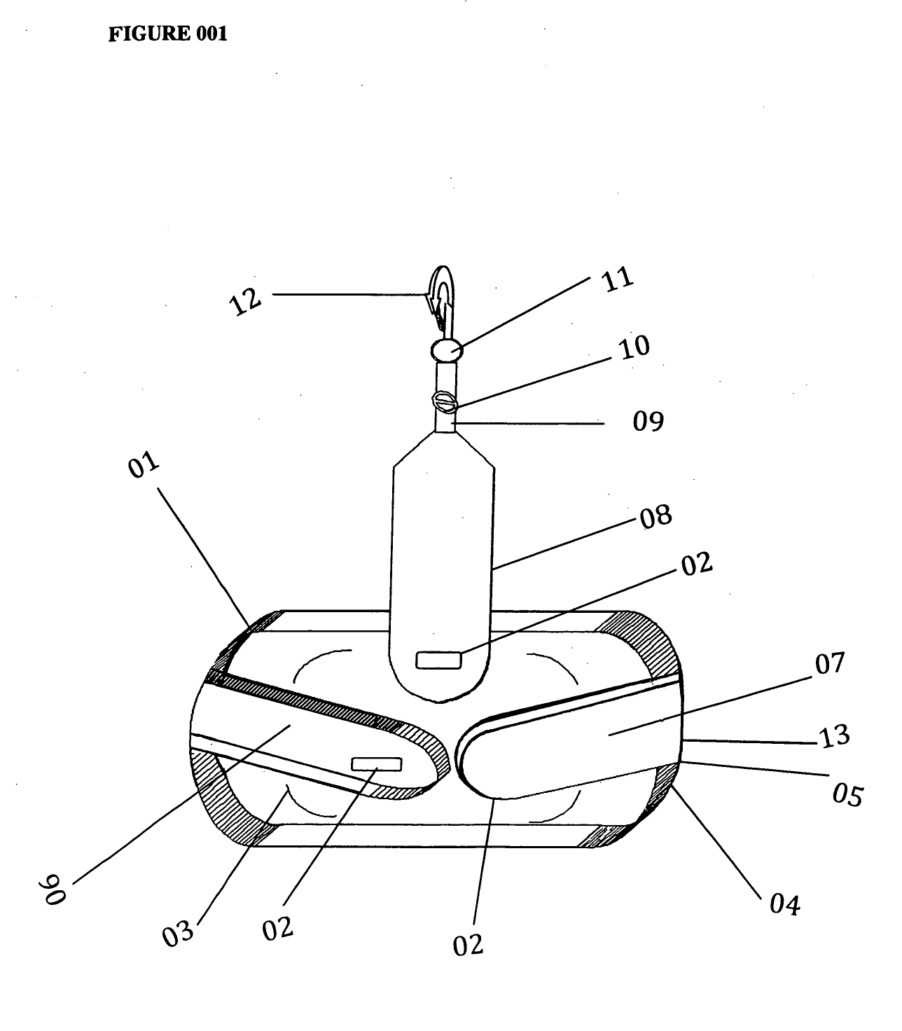

FIG. 1

FIG. 001 A front view of the child safety head harness that shows all components of the apparatus except the elastic rear band [04] and the non stretch adjustable band [05],[13]- located in the rear of the device. The base [01] is firm and raised on the top with cushioning [03] which creates a pillow top effect. The base has extending cushioned right and left arms [06] and [07] on each side that fold across the front of the child safety head harness over-lapping. The cushioned [03] right and left arms[06] and [07] are accompanied by a detachable cushioned [03] middle arm[08] that extends down the front middle of the passengers fore head connecting to the cushioned[03] right and left arms[06] and [07] with Velcro [02]connectors on each arm; on top and bottom of the right arm[06], on the bottom of the left arm[07], and on the top of the middle arm[08]. The cushioned [03] middle arm[08] is shown having an adjustable strip [09], with an adjuster [10], a circle ring [11] that is all connected to a hook fastener [12] that fastens to the vehicle on the opposite end of the cushioned [03] middle arm[08]

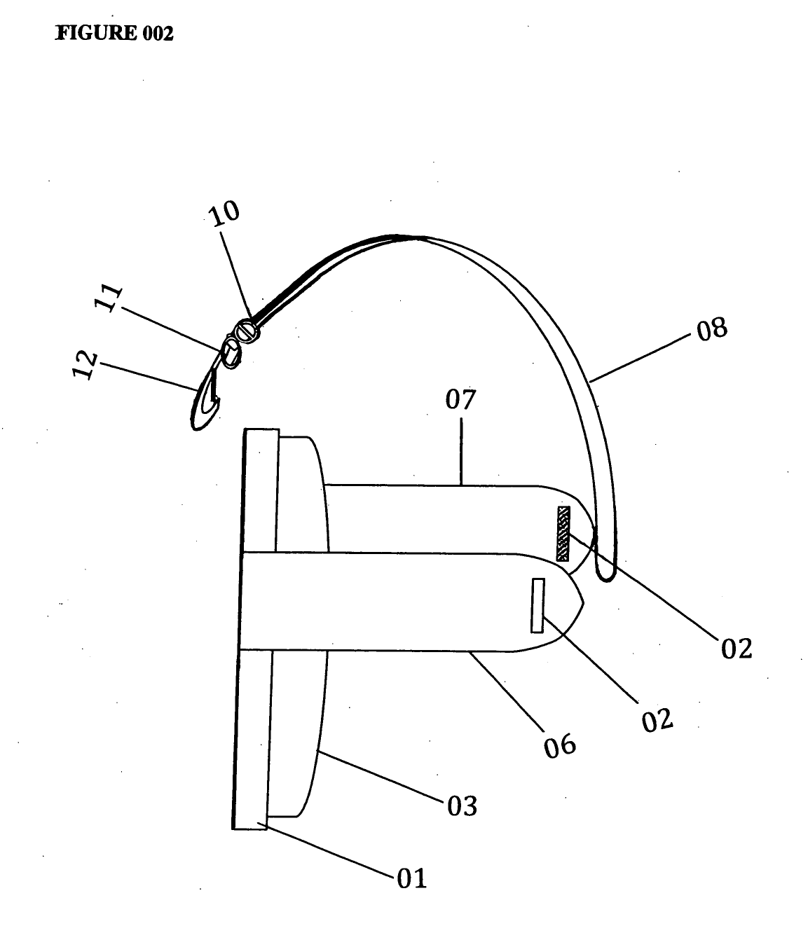

FIG. 002—A side view of the child safety head harness showing the cushioned [03] base [01] and an outward extended view the cushioned [03] right and left arms [06] and the cushioned [03] middle arm [08 having an adjustable strip [09], with an adjuster [10], a circle ring [11] that is all connected to a hook fastener [12] that fastens to the vehicle on the opposite end of the cushioned [03] middle arm[08].

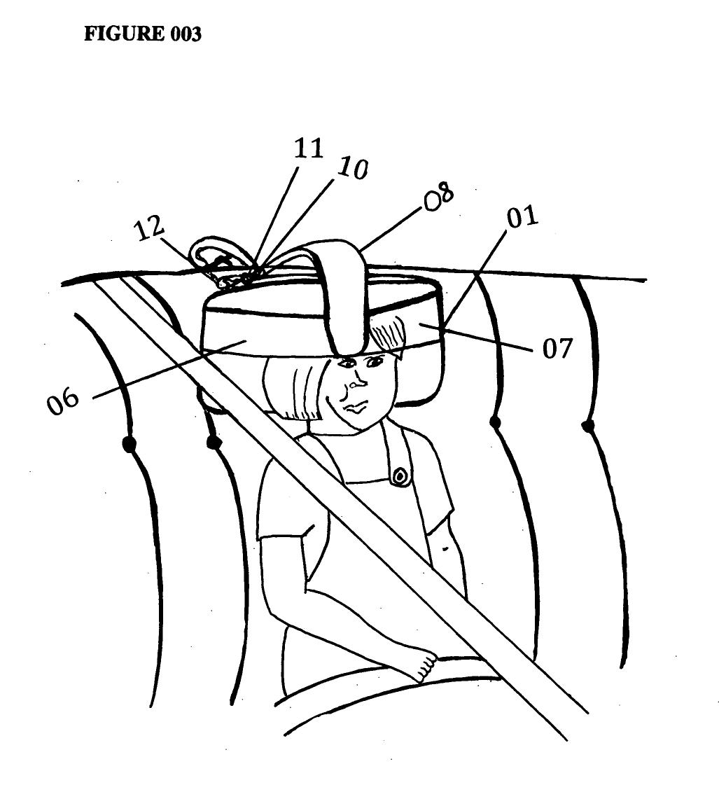

FIG. 003—The front view of the child safety head harness from the inside of a vehicle placed on a child that shows how the apparatus is used on a passenger one of several ways connecting the apparatus to a vehicle. This view shows the cushioned [03] base [01] with cushioned [03] right and left arms[06] and [07] accompanied by the detachable cushioned [03] middle arm[08] that extends down the front middle of the passengers fore head connecting to the cushioned[03] right and left arms[06] and [07] with Velcro connectors on each arm; on top and bottom of the right arm[06], on the bottom of the left arm[07], and on the top of the middle arm[08]. The cushioned [03] middle arm[08] is shown having an adjustable strip [09], with an adjuster [10], a circle ring [11] that is all connected to a hook fastener [12] that fastens to the vehicle on the opposite end of the cushioned [03] middle arm[08].

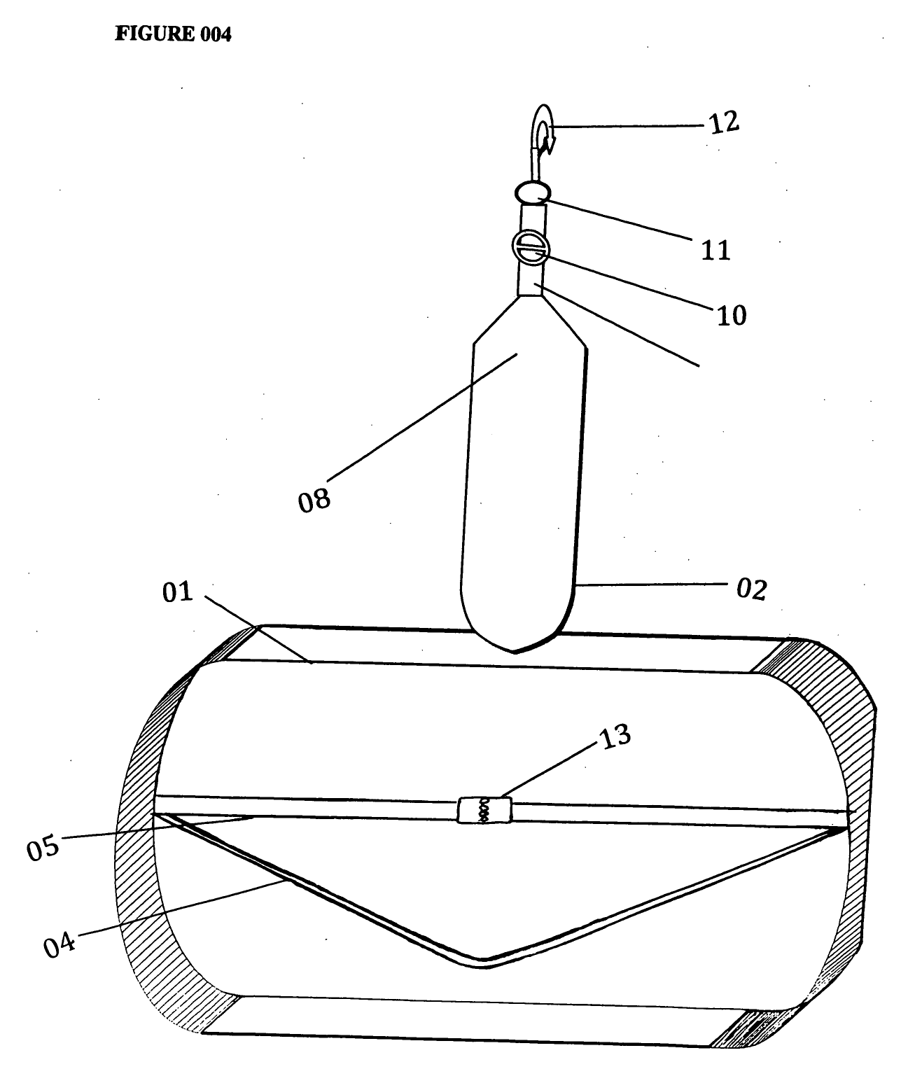

FIG. 004—A back view of the child safety head harness showing the cushioned [03] base [01] of the child safety head harness with a cushioned [03] middle arm [08] having an adjustable strip [09], with an adjuster [10], a circle ring [11] that is all connected to a hook fastener [12] that connects to the vehicle on the opposite end of the cushioned [03] middle arm [08]. FIG. 003 also shows an elastic pulley [04] that extends across the back of base [01] of the child safety head harness that is used connect to the vehicle seat platform as one of several connection methods. FIG. 003 also shows the back view of the child safety head harness with a non-stretch strip [05] in the rear that is adjustable by the fastener [13]. The non-stretch strip [05] is used connect to the vehicle seat platform as one of several connection methods

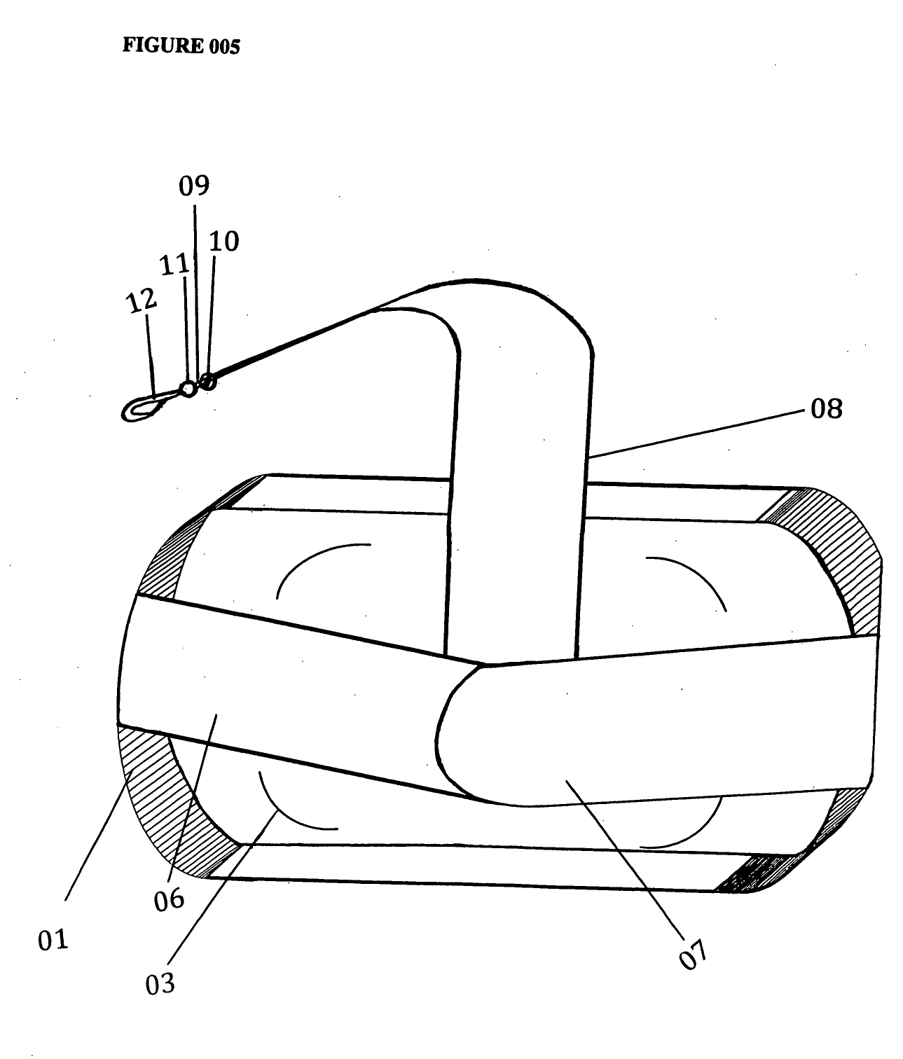

FIG. 005—The front view of the child safety head harness displaying the structure of the the apparatus. This view shows cushioned [03] base [01] with the cushioned [03] right and left arms[06] and [07] accompanied by the detachable cushioned [03] middle arm[08] used to secure the front middle of the passengers fore head connecting to the cushioned[03] right and left arms[06] and [07] with Velcro [02]connectors on each arm; on top and bottom of the right arm[06], on the bottom of the left arm[07], and on the top of the middle arm[08]. The cushioned [03] middle arm[08] is shown having an adjustable strip [09], with an adjuster [10], a circle ring [11] that is all connected to a hook fastener [12] that fastens to the vehicle on the opposite end of the cushioned [03] middle arm[08].

I claim:

1. A safety head harness and pillow vehicle seat device for improving head, neck, positioning and spinal alignment comprising: a) base board having a firm bottom and a cushioned top, a cushioned middle front strap with closure, side straps attached to each side of base with end closures and pulleys on the on the beck panel of said base

2. A safety head harness and pillow vehicle device according to claim 1, wherein said base is adapted to be mounted to the upper front of the child car seat fastened in the back of child car seat including at least one pulley.

3. A safety head harness and pillow vehicle device according to claim 1, wherein said base is adapted to be mounted to the upper front of the child booster seat fastened in the back of train seat including at least one pulley.

4. A safety head harness and pillow vehicle device according to claim 1, wherein said base is adapted to be mounted to the upper front of the train seat fastened in the back of train seat including at least one pulley.

5. A safety head harness and pillow vehicle device according to claim 1, wherein said base is adapted to be mounted to the upper front of the airplane seat fastened in the back of airplane seat including at least one pulley.

6. A safety head harness and pillow vehicle device according to claim 1, wherein said base is adapted to be mounted to the upper front of the stand alone vehicle seat fastened in the back of standalone vehicle seat including at least one pulley.

7. A safety head harness and pillow vehicle device according to claim 1, wherein said base is adapted to be mounted to the upper front of the combined back passenger seats each with metal loop on back of the combined passenger seats fastened in the back with closure.
